(19) United States
(12) Patent Application Publication
(10) Pub. No.: US 2002/0015547 A1
(43) Pub. Date: Feb. 7, 2002

(54) Compact multi-channel polarization mode dispersion compensator

(76) Inventor: Jay S. Patel, State College, PA (US)

Correspondence Address: YAFO NETWORKS, INC., 1340 F CHARWOOD RD., HANOVER, MD, 21076, US

(21) Appl. No.: 09/754,546

(22) Filed: Jan. 5, 2001

Related U.S. Application Data
(60) Provisional application No. 60/174,807, filed on Jan. 7, 2000.

(51) Int. Cl. G02B 6/00

(52) U.S. Cl. 385/11; 359/494

(57) ABSTRACT

A polarization mode dispersion (“PMD”) compensator that includes high birefringence media (such as crystals or polarization maintaining fiber) for introducing differential group delay (“DGD”) between polarization modes of an optical signal and polarization control elements to generate tunable delay is provided. Compensation of first and higher order PMD can be achieved in a compact geometry. Furthermore, the compact nature of the geometry allows a plurality of PMD compensators to share birefringent media and polarization controllers, which can be two-dimensional arrays of liquid crystal cells. Stacking the cells and using a folded beam geometry can achieve a compact geometry.

### CROSS-REFERENCE TO RELATED APPLICATION

This claims priority under 35 U.S.C. 119(e)(1) to U.S. Provisional Patent Application No. 60/174,807, filed Jan. 7, 2000, which is hereby incorporated by reference in its entirety.

### FIELD OF THE INVENTION

This invention relates to methods and apparatus for compensating polarization mode dispersion (hereinafter, “PMD”), and more particularly, to single and multi-channel compensation techniques for reducing first and higher order PMD.

### BACKGROUND OF THE INVENTION

PMD is generally recognized as a problem for high bit transmission rates that use, for example, time domain multiplexing. One solution to this problem is to compensate the PMD by using some form of active compensation.

To understand conventional compensation techniques, it is first necessary to understand how PMD arises. Generally, PMD is introduced into an optical signal during transmission along an optical fiber because small stresses in the fiber induce eccentricities into the normally circular fibers. These eccentricities cause the light to propagate at slightly different velocities along two orthogonal directions. A typical fiber, which could be hundreds of kilometers long, normally undergoes varying degrees of stress along its length. That length can be approximated as a number of concatenated shorter sections in which the two propagating velocities are constant within each section. This is known to result in a certain phase delay between the two polarization modes. The principal optical axis in various sections may be randomly oriented with respect to each other. Generally, light propagation through fibers can be described using Jones matrices.

There are at least two generic methods of compensating for the differential group delay (hereinafter, “DGD” ) that normally exists between the two polarization modes. The first method involves physically separating the two pulses with different velocities, correcting for the differential delay and recombining the two pulses. The second method involves compensating the delay by a mechanism similar to the one that originally produced the delay.

In the first method, the PMD vector (i.e., the vector representing the DGD magnitude and angle) of the compensating element is fixed and aligned along the S₁ direction, as represented on a Poincaré sphere. To compensate with this type of system, one must first adjust the PMD vector of the compensator so that it lines up along the S₁ direction, and then control the vector's length (i.e., magnitude), such as by adjusting the two variables θ and φ.

For example, FIG. 1 shows a block diagram of optical system 100 for changing the direction of a PMD vector by rotating it to a linear direction by adding PMD using a fiber with a polarization rotator. FIG. 1 also shows a series of schematic representations on a Poincaré sphere of how the direction of a PMD vector can be rotated to a linear direction using the system. In this way, then, the problem is reduced to adjusting the length of the vector, which is typically done by using polarization splitting elements and controlling the delay in one of the paths.

FIG. 2 shows a block diagram of optical system 200 for compensating a PMD vector using a linear polarization beam splitter after the system PMD is made linear with a polarization controller. FIG. 2 also shows two schematic representations on a Poincaré sphere of PMD vector compensation using the system.

A second method of compensation uses a birefringent fiber of the appropriate length to correct for the delay. In some cases, the delay is adjusted by optical means, although there are examples in which the PMD is corrected by launching an optical signal having the correct state of polarization (hereinafter, “SOP” or simply polarization) into the fiber as described in Hass et al. U.S. Pat. No. 5,311,346, the disclosure of which is incorporated by reference in its entirety.

During first order correction of PMD, in which the PMD afflicted optical signal is bandwidth limited, only the differential delay needs to be corrected. FIG. 3 shows a schematic representation of PMD compensator 300 using multiple birefringent fibers. Such compensators are described by Ozeki et al. and Patscher et al. (“A Polarization-Mode-Dispersion Equalization Experiment Using A Variable Equalizing Optical Circuit Controlled By A Pulse-Waveform-Comparison Algorithm,” OFC'94 Technical Digest, at 62-64 (1994) and “A Component For Second-Order Compensation Of Polarisation-Mode Dispersion” in Electronics Letters, Vol. 33, No. 13., at 1157-1159 (Jun. 19, 1997), respectively) the disclosures of which are incorporated by reference in their entireties. No mention is made, however, how the polarization transformations are achieved.

Just as the SOP of an optical signal can be represented as a vector on a Poincaré sphere, the PMD of the system can be represented as a PMD vector Ω. Consider, for example, a uniform section of a birefringent medium that is uniaxial. For such a system, there are two principal axes, which correspond to the slow axis and the fast axis. The directions of these two axes are also the eigenvectors of the system and, because of the simplicity of the system being considered, these two directions can also be the directions of the two orthogonal SOPs (see FIG. 4).

Thus, the two principle polarization states are horizontally and vertically polarized light components and correspond to the intersection of Ω and the Poincaré sphere at S₁=1 and S₁=−1, respectively. The length of the vector gives the magnitude of the differential group delay, which in this case corresponds to the difference in the optical path length along the slow and the fast axes of the birefringent medium. Therefore, the length of Ω is directly proportional to the length of the birefringent medium.

It will be appreciated that, in general, the eigenstate of an optical system is not necessarily the same as principle state. It will be further appreciated that, in the case of a uniform birefringent system, the principal states are linear and the two states are orthogonal to one another.

The system also produces polarization mode dispersion, which results in pulse splitting, much like the case of a uniform birefringent system. In the case of a uniform birefringent system, the pulse delay is simply the amount of phase retardation and the time difference (i.e., DGD) between the pulses is given by:

τ=((nₛ−nᵢ)L)/c,

where L is the length of the fiber, nₛ and nᵢ are the indices for the two principal modes and c is the velocity of light in a vacuum. The above expression also holds true in the case of complex optical fiber systems, except that the difference in principle mode indices can be substituted with an effective index difference.

The following example illustrates the concept of the principle state. In this example, a first order correction can completely compensate the PMD. FIG. 5 shows a schematic representation of system 500 that includes two identical but orthogonal birefringent media. FIR. 5 also includes schematic representations on a Poincaré sphere of the associated PMD vectors. In this case, the two birefringent media (e.g., crystals) are oriented at 90 degrees with respect to one another. One crystal introduces a certain amount of PMD and the second crystal compensates for the introduced PMD. As shown in FIG. 5, the effect of the first and second crystals can be represented as PMD vectors on a Poincaré sphere that have the same magnitude and an opposite directions. The PMD vectors therefore cancel exactly.

FIG. 6 shows a schematic representation of system 600 that includes two identical but orthogonal birefringent media at 45 degrees to each other. FIG. 6 also includes schematic representations on a Poincaré sphere of the associated PMD vectors and a net PMD vector. In this case, medium 620 has its uniaxial direction oriented at 45 degrees relative to medium 610. Regardless of the length of the crystals, however, full PMD compensation is impossible because the two associated vectors are orthogonal to each other. The net PMD of the system will therefore depend on the vector sum of the two Stokes vectors.

FIG. 7 shows yet another system that includes two different types of birefringent sections and a Poincaré sphere representation of the PMD vectors. In system 700, section 710 can be a half wave plate and section 720 can be a birefringent medium (e.g., crystal) that has a fairly large PMD (as indicated by the crystal length). For system 700, the PMD vector always lies in the S₁, S₂ plane as the angle between the principle axes of the half wave plate is rotated with respect to the birefringent crystal. For monochromatic light, the incident polarization is rotated by 2θ.

If the polarization after the first wave plate coincides with the principle axis of the birefringent crystal, then, the principle axis is one of the principal states of the system. This is true to first order when the light is linearly polarized and oriented at −2θ with respect to the principal axis of the crystal. The length of the PMD vector, however, is essentially constant, although a slight change is possible because of the algebraic addition or subtraction of the overall differential length of the system (i.e., the length of the PMD vector).

The length of the PMD vector is not necessarily constant, however, for a system in which crystal 720 is of comparable length to the optical thickness of half wave plate 710. In this case, it would be possible to continuously change the length of the PMD vector as well, but this requires a system in which the overall length of the electro-optic device is fairly long to produce large PMD by itself.

We note that this analysis is not exact because the principal state is defined as that state for which the derivative of the phase matrix with respect to ω is zero. Nevertheless, the exact calculation has been performed and has revealed that the representation shown by FIG. 7 is nearly exact.

It would therefore be desirable to provide a compact polarization mode dispersion compensation system using essentially two or more birefringent crystals and polarization controllers.

### SUMMARY OF THE INVENTION

It is therefore an object of this invention to provide a compact polarization mode dispersion compensation system using essentially two or more birefringent elements (i.e., crystals or polarization maintaining fibers) and polarization controllers.

Thus, in accordance with this invention, methods and apparatus for compensating polarization mode dispersion (hereinafter, “PMD”), and more particularly, single and multiple channel compensation techniques for reducing first and higher order PMD are provided.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which

FIG. 1 shows a block diagram of an optical system for changing the direction of a PMD vector by rotating it to a linear direction by adding PMD using a fiber with a polarization rotator and a series of schematic representations on a Poincaré sphere of how the direction of a PMD vector can be rotated to a linear direction using the system.

FIG. 2 shows a block diagram of an optical system for compensating a PMD vector using a linear polarization beam splitter after the system PMD is made linear with a polarization controller and schematic representations on a Poincaré sphere of compensation of a PMD vector using the system.

FIG. 3 shows a schematic representation of a PMD compensator using multiple birefringent fibers.

FIG. 4 shows a PMD vector on a Poincaré sphere.

FIG. 5 shows a schematic representation of a system that includes two identical but orthogonal birefringent media at 90 degrees to each other and schematic representations on a Poincaré sphere of the associated PMD vectors.

FIG. 6 shows a schematic representation of a system that includes two identical but orthogonal birefringent media at 45 degrees to each other and schematic representations on a Poincaré sphere of the associated PMD vectors and a net PMD vector.

FIG. 7 shows a schematic representation of a system for PMD compensation that includes a birefringent medium and a half wave plate at angle θ.

FIG. 8 shows an illustrative PMD compensation system including a polarization controller followed by a series of elements consisting of polarization adjusting elements and fixed birefringent media (e.g., crystals) according to this invention.

FIG. 9 shows another illustrative PMD compensation system that includes multiple PMD compensators using a two-dimensional polarization controller followed by a series of two-dimensional elements consisting of two-dimensional polarization-adjusting elements and fixed birefringent media according to this invention;

FIG. 10 shows yet another PMD compensation system that includes multiple PMD compensators using a two-dimensional first polarization controller followed by a series of two-dimensional elements consisting of two-dimensional polarization adjusting elements and fixed birefringent media in an example of folded geometry according to this invention;

FIG. 11 shows a three-cell configuration of a polarization controller that allows endless arbitrary control of the polarization of incident light from the optical fiber in a plane. The angle indicated under each plate refers to the angle that the fast axis of a parallel-aligned liquid crystal cell makes with respect to the fast axis of the birefringent crystal according to this invention;

FIG. 12 shows a PMD source and illustrative compensator according to this invention;

FIG. 13 shows the axial orientation of a birefringent crystal. The propagation axis lies perpendicular to both the slow and the fast axis.

FIG. 14 shows the axial orientation of two birefringent media and a single liquid crystal cell with the fast and the slow axes rotated with respect to the birefringent media's axes by 45 degrees.

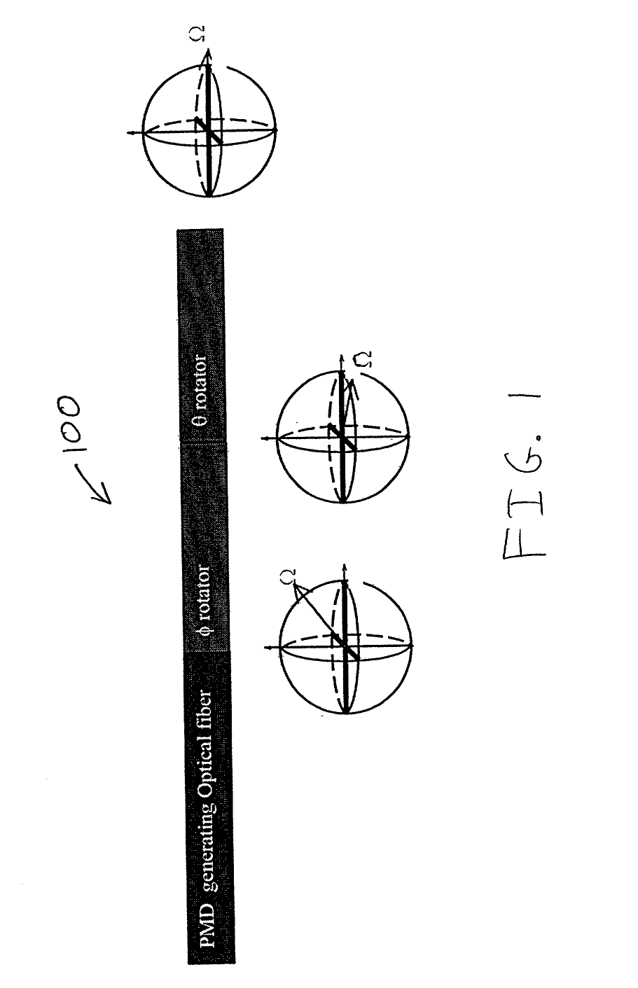

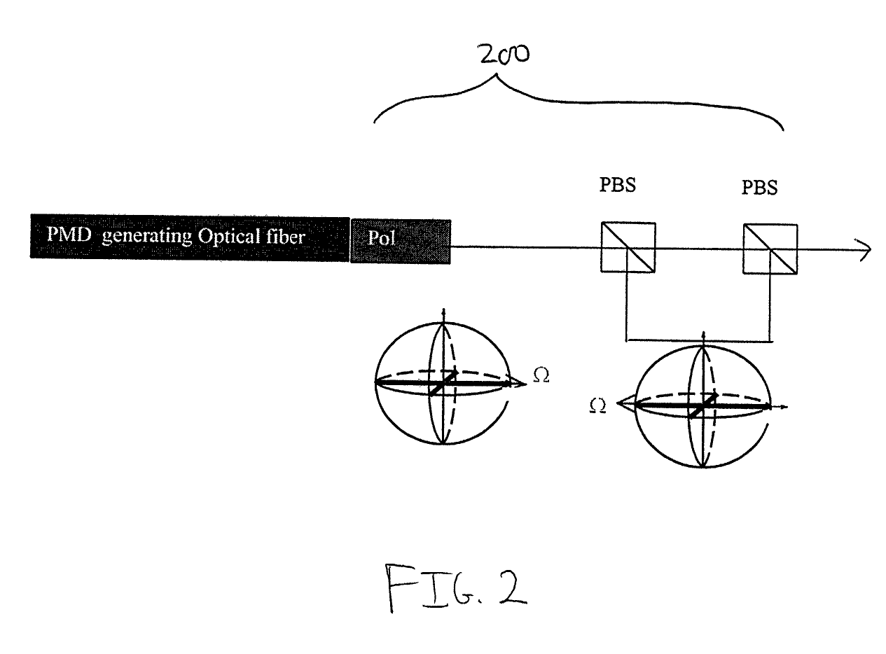

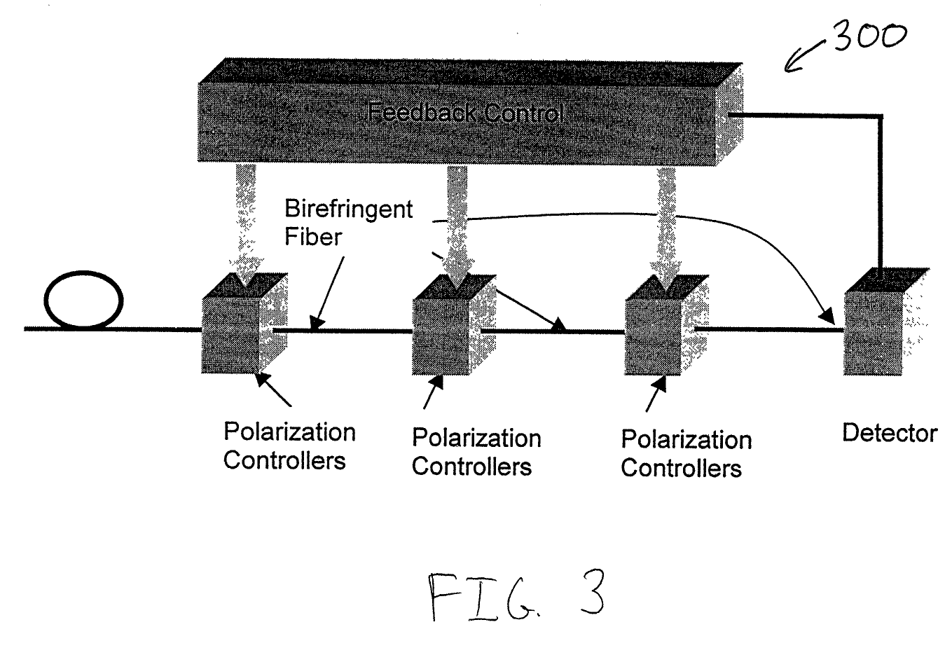

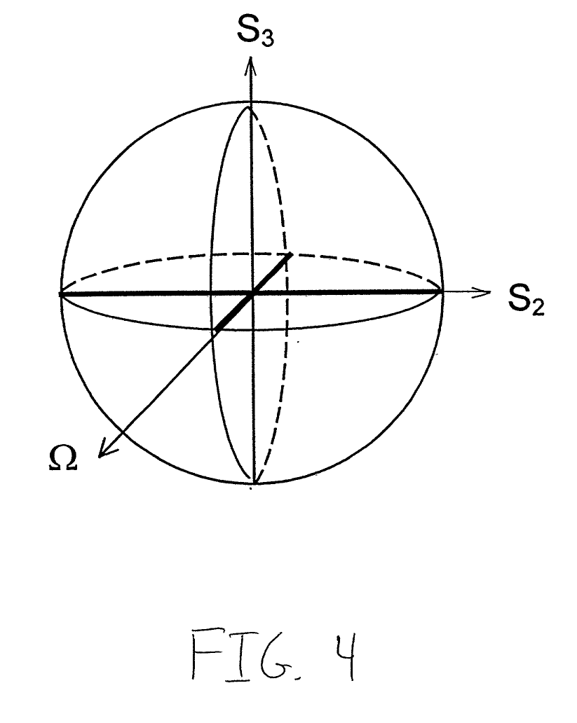

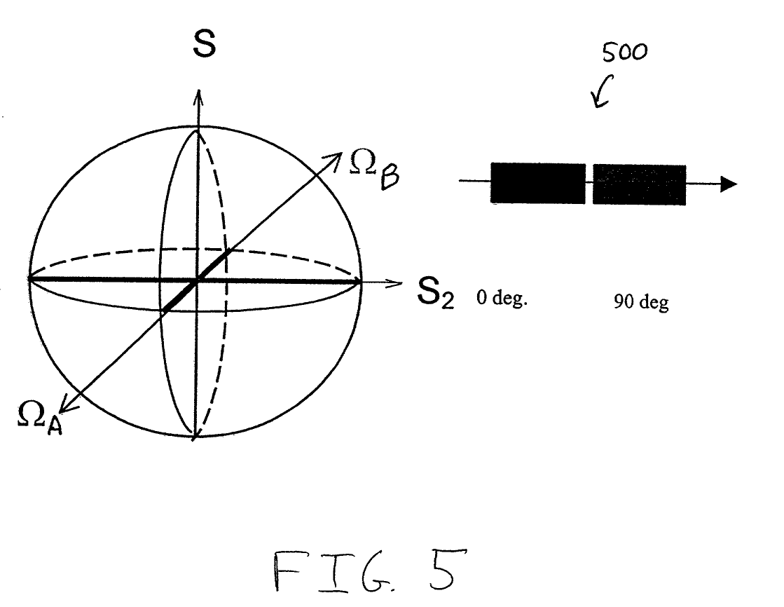

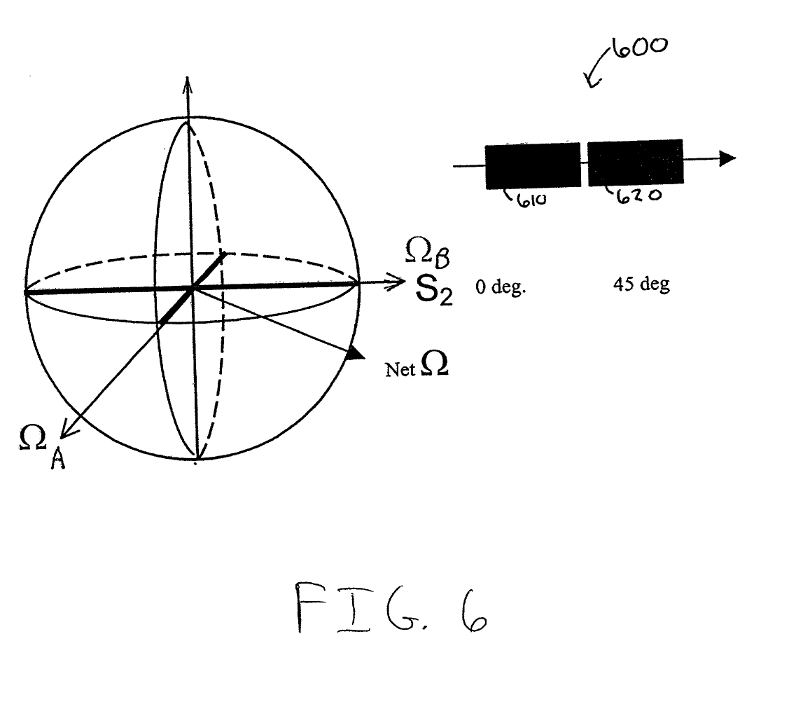

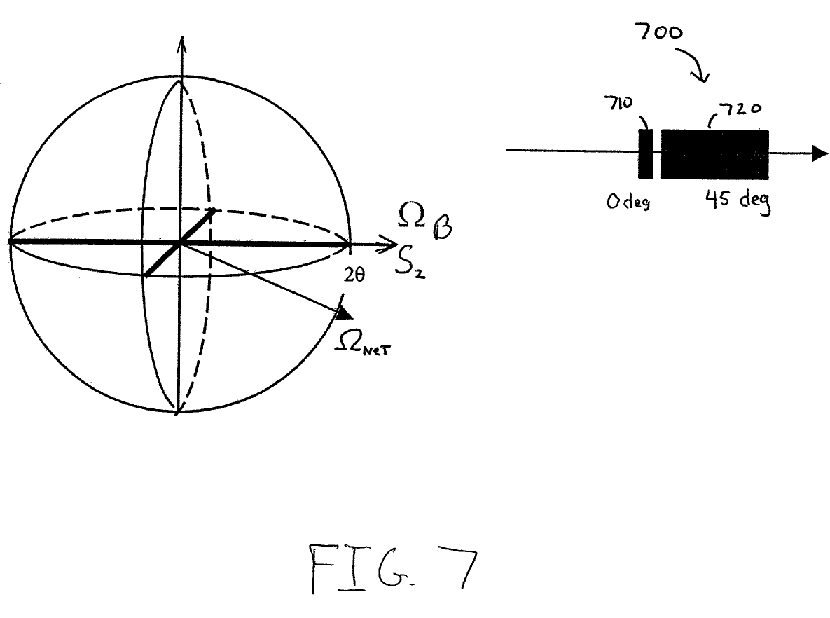

### DETAILED DESCRIPTION OF THE INVENTION

The present invention uses high birefringence media (e.g., crystals or polarization maintaining fiber) for introducing DGD between polarization modes of an optical signal and uses polarization control elements to generate tunable delay. Apparatus constructed according to the principles of this invention can be used to compensate for first and higher order PMD in a compact geometry. Furthermore the compact nature of the geometry allows a plurality of PMD compensators share birefringent media and polarization controllers, which can be spatially distributed in the form of two-dimensional arrays. By using liquid crystal cells as polarization controllers, the whole structure can be integrated by stacking the cells into a compact geometry, which can be further reduced in size by beam folding.

Generally, light from an optical fiber is collimated and then passed through a polarization adjustor to control the input polarization to a birefringent crystal. The light that emerges from the birefringent crystal can again be controlled with another adjuster before entering the second birefringent crystal. It will be appreciated that the following description of a single controller element also applies to reflected geometries and multiple element (i.e., multi-channel) architectures.

The polarization controller could be a stack of liquid crystal cells that allows limited or complete control of the polarization of the light. For example, complete endless control can be achieved using three cells, whereas limited rotation can be achieved with less, including only one active LCD and two quarter wave plates (or two more LCDs). The birefringent media are preferably cut such that the wave propagation axis is perpendicular to the optic axis of the crystal. This has the effect of not displacing the beam but at the same time allowing the maximum, possible group delay between the two principle polarization modes.

The orientation of the liquid crystal cells, which are made in a particular configuration using nematic liquid crystals (such that its “director” axis), is uniform throughout the cell in the field off state. The application of the field results in tilting of the director field in a non-uniform manner but essentially in plane. This also contains the original director field. Such a liquid crystal device behaves essentially as a variable retardation plate which has a well defined slow and a fast axis, but one in which the effective index corresponding to the fast axis can be changed by changing the magnitude of the applied electric field.

A number of PMD compensation systems that may use such liquid crystal devices according to this invention are described below.

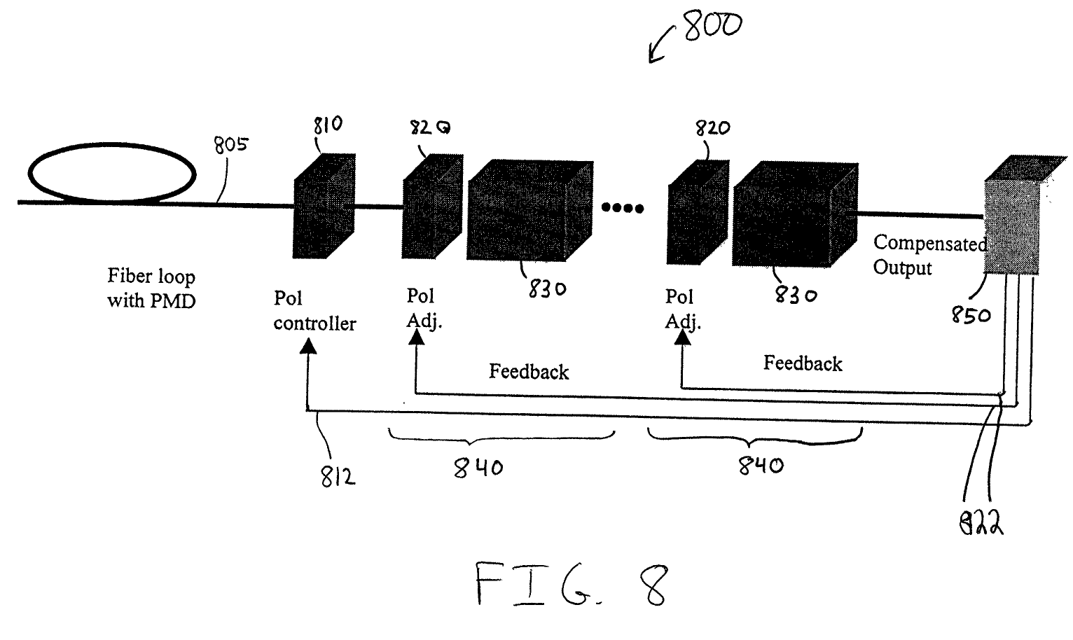

FIG. 8 shows illustrative PMD compensation system 800 including polarization controller 810 followed by a series of optical elements consisting of polarization adjusting elements 820 and 820 and fixed birefringent media 830 and 830 according to this invention. It will be appreciated that the number of controllers, adjusters, and media could be more or less and is a matter of design.

In particular, controller 810 is coupled to receive an optical input signal that has a polarization and at least some PMD. According to this invention, system 800 introduces compensatory delay to counter optical input signal delay caused by the PMD in the signal. In addition to controller 810, compensator 800 includes a plurality of tuning modules 840, and distortion detector 850.

During operation, polarization controller 810 receives the optical input signal from a fiber that introduces PMD and controller feedback signal 812 provided by detector 850. Controller feedback signal 812 causes controller 810 to adjust its retardance such that the polarization of optical input signal is aligned with the first of adjusters 820 when it emerges from controller 810.

Tuning modules 840 are each connected in series with and downstream from controller 810. Each tuning module at least includes polarization adjustor 820 and birefringent medium (e.g., crystal) 830. Adjuster 820 has a variable retardance and receives an optical input signal from the output of the previous optical component (e.g., controller 810 or birefringent medium 830 from a previous tuning module). Adjuster 820 also receives adjustor feedback signal 822 (which controls the retardance of adjusters 820) from distortion detector 850.

Each of tuning modules 840 also includes fixed length birefringent medium 830 that receives the signal from the adjustor of the same module and produces a compensated optical output signal. The output signal preferably has a polarization that is aligned with the input of birefringent medium 830 when it emerges from adjustor 820. Distortion detector 850 receives at least partially compensated optical output signal from the last serial tuning module and provides controller and adjustor feedback signals 812 and 822, respectively, for compensating the delay in the original optical input signal.

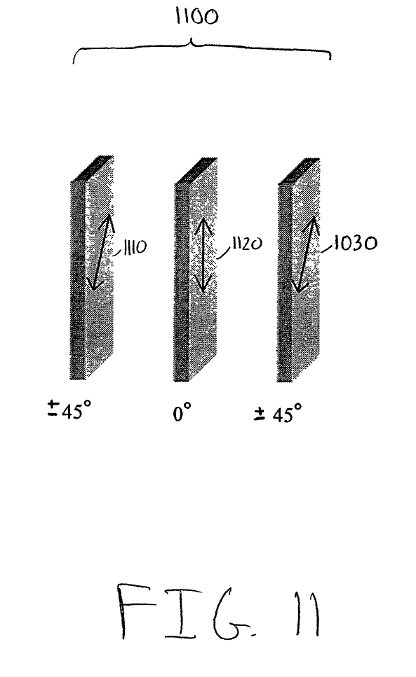

Controller 810 can include a stacked liquid crystal structure (such as the one shown in FIG. 11) having a retardance that can be controlled with the controller feedback signal to align the polarization of the input signal in any desired direction for subsequent optical processing. The liquid crystal structure can include three or more stacked liquid crystals that provide endless retardation adjustment to align the polarization of the optical input signal with a following optical component. It will be appreciated that any individual liquid crystal can be substituted with two more crystals that work together in order to reduce the total amount of retardation that the substituted crystal must ordinarily produce.

Alternatively, controller 810 can include one liquid crystal, cascaded with at least one other retardation element, which can be active liquid crystals or a passive wave plate. Or, in yet another alternative embodiment, controller 810 can include two quarter-wave plates, which, in conjunction with the liquid crystal, provide limited control of polarization of the optical input signal. It will be appreciated that any of adjustors 820 can be constructed in a manner similar to controller 810.

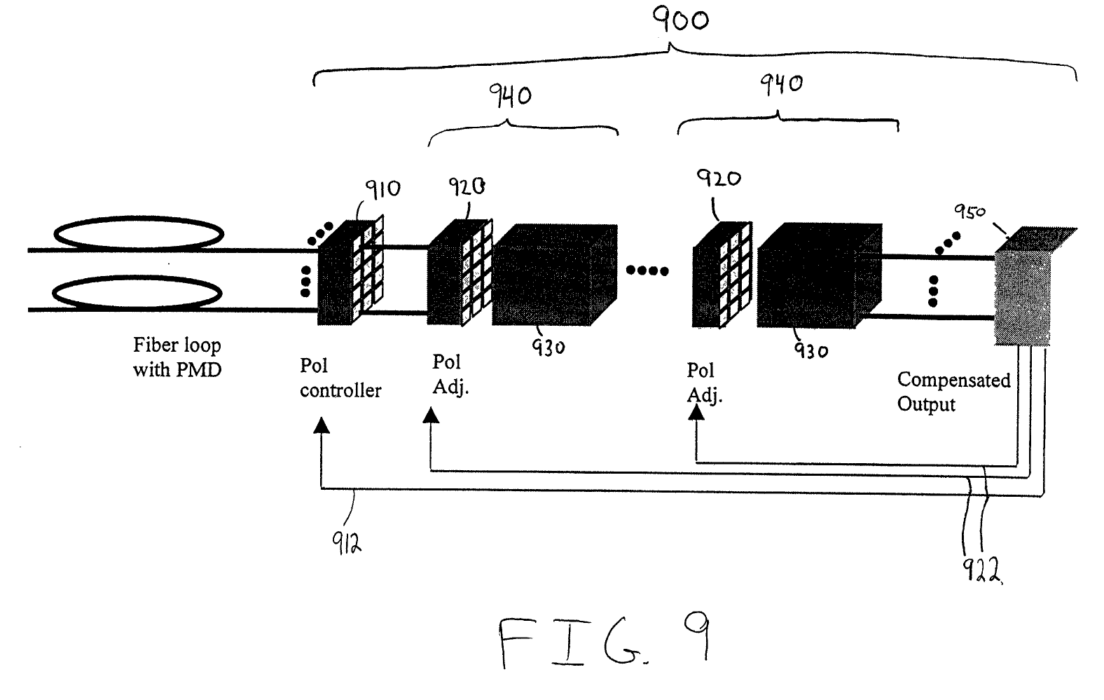

FIG. 9 shows illustrative multi-channel PMD compensation system 900, which includes multiple parallel PMD compensators using a two-dimensional polarization controller 910 followed by a series of two-dimensional elements, which include a two-dimensional array of polarization adjusting elements 920 and fixed birefringent media 930. Two-dimensional arrays of elements can be constructed, for example, using conventional liquid crystal cell manufacturing technology in which multiple individually controlled cells are placed in a single device.

During operation, compensator 900 is normally coupled to receive multiple optical input signals, each having some PMD. Compensator 900 can introduce compensatory delay to each channel separately to counter the multiple optical input signal delays caused by PMD.

Compensator 900 includes polarization controller 910 that receives the multiple optical input signals and controller feedback signal 912. Signal 912 causes controller 910 to adjust the retardance of each of its respective elements such that the polarizations of each of the optical signals is appropriately aligned as it emerges from controller 910.

Compensator 900 also includes multiple tuning modules 940 that are connected in series with and downstream from controller 910. Each tuning module includes a two-dimensional polarization adjustor 920 (which has a two-dimensional array of retardances). Adjuster 920 can receive multiple adjustor feedback signals 922 and at least one of the compensated optical output signals from either (1) controller 910 or (2) another tuning module 940. Adjustor feedback signals 922 control the retardances of the individual adjuster elements such that the polarization of each of the optical signals passing therethrough is appropriately aligned when it emerges from adjustors 920. Each of tuning modules 940 also includes fixed length birefringent medium 930 that can receive multiple optical signals from a previous adjustor 920 and produces respective compensated optical output signals.

Like compensator 800, compensator 900 also includes distortion detector 950, which can receive a plurality of at least partially compensated optical signals from the last tuning module 940 and provides to controller 910 and adjustor 920 feedback signals 912 and 922 to compensate for the delay caused by the PMD in each of the optical signals.

It will be appreciated that controller 910 and adjusters 920 can be constructed in substantially the same ways as previously described with respect to controller 810 and adjusters 820 of FIG. 8, except that a two dimensional array of such controllers and adjusters should be used.

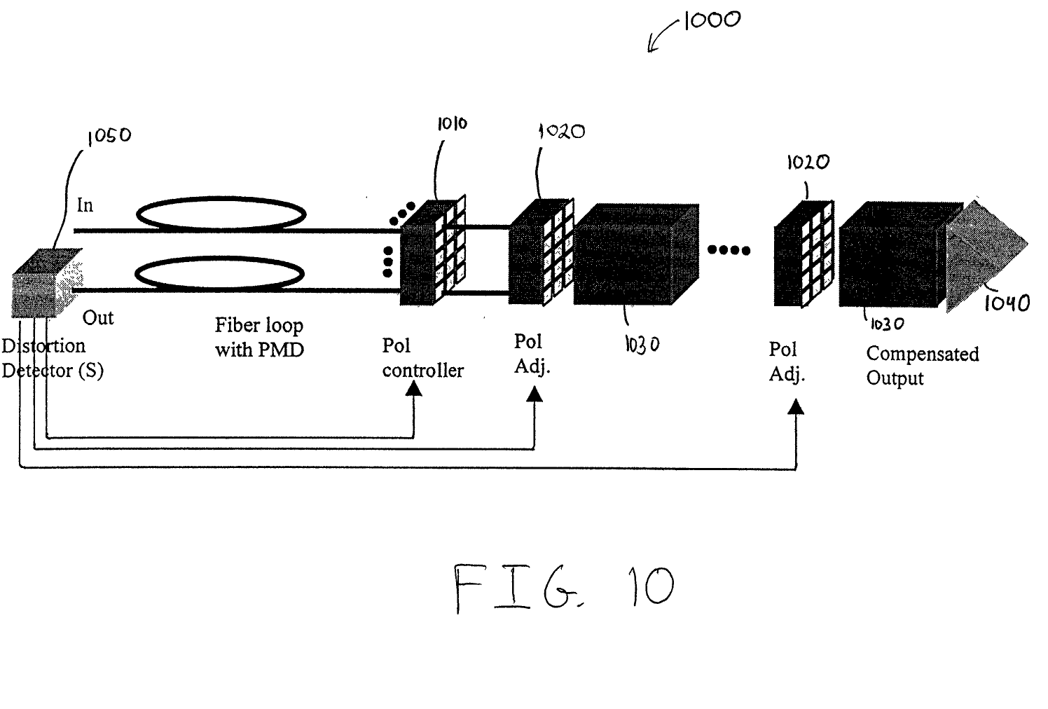

FIG. 10 shows yet another PMD compensation system 1000 that includes multiple parallel PMD compensators using two-dimensional polarization controller 1010 followed by a series of two-dimensional adjusters 1020. Controller 1010 and each of adjusters 1020 includes a two-dimensional array of polarization adjusting elements. After each adjuster, fixed birefringent media 1030 are positioned and after the last medium there is at least one optical reflector 1040 that allows for a folded optical geometry.

Distortion detector 1050 is located at the opposite end of compensator 1000 as reflector 1040. In this case, an optical signal would pass through each of the optical components twice before reaching distortion detector 1050. It will be appreciated, however, that one or more reflectors can be used on both ends of compensator 1000 so that the optical signal passes through each of the optical components more than twice. In this case, detector 1050 can be positioned on the same end as either of the reflectors. Moreover, two or more optical signals can be compensated simultaneously using compensator 1000.

FIG. 11 shows illustrative three liquid cell polarization controller 1100 that allows endless arbitrary control in a plane of the polarization of incident light from an optical fiber. The angle indicated in FIG. 11 under each of cells 1110, 1120, and 1130 refers to the angle that the fast axis of each parallel-aligned cell makes with respect to the fast axis of a birefringent crystal (not shown) according to this invention.

Three or more liquid crystal cells can be aligned and optionally stacked to make an arbitrary polarization transformer that allows any polarization state to be transformed into any other arbitrary polarization state, provided that cells 1110, 1120, and 1130 are arranged such that the angular difference between the fast axis of any two adjacent plates are 45 degrees to each other. If the output or the input polarization state is known, then it is possible to reduce the number of required liquid crystal cells to two. Because retardance control of two cells, which are oriented at 45 degrees to each other, arbitrary control is enabled in both the θ and φ rotational directions.

Precise first order PMD compensation is possible by combining a first polarization controller, a second birefringent crystal, a liquid crystal polarization controller, and another wave plate. A combination of voltages applied across the different liquid crystal cells can produce the desired result, which is best understood by considering the compensator as a series of sections.

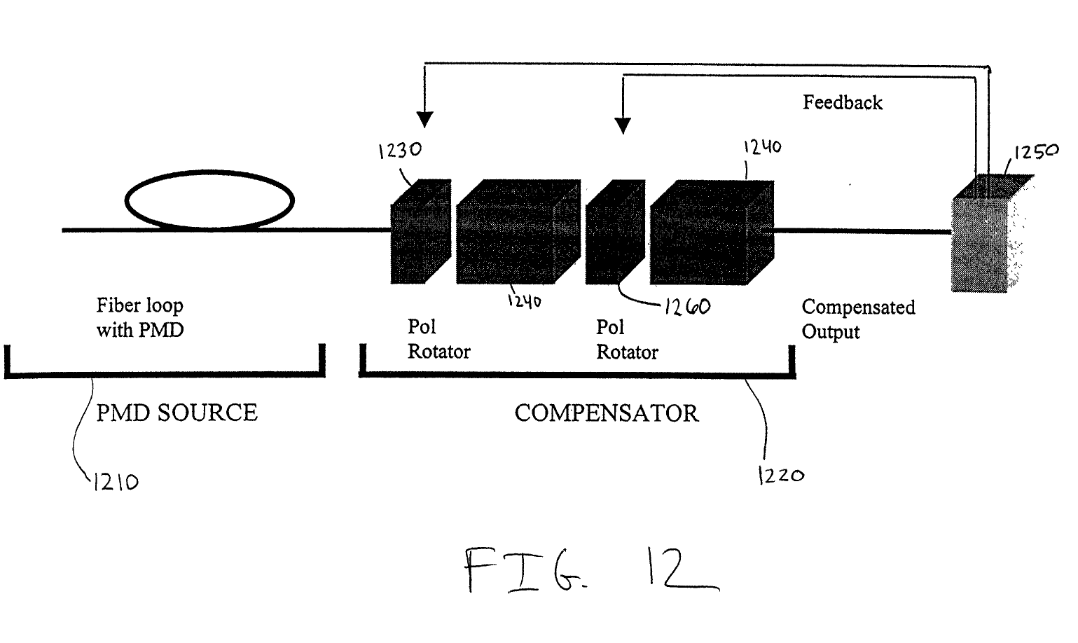

FIG. 12 shows PMD source 1210 and illustrative PMD compensator 1220 according to this invention. Compensator 1220 includes polarization controller 1230 (such as one or more liquid crystal cells) and then two birefringent media 1240 (e.g., calcite crystals ) in combination with intermediate polarization controller 1260, which lies between crystals 1240. The latter portion primarily controls the length of the PMD vector (i.e., the delay in the group velocities for the two modes). Intervening rotator 1260 can be a stack of liquid crystal cells, or even a tunable wave plate, such as a single liquid crystal cell.

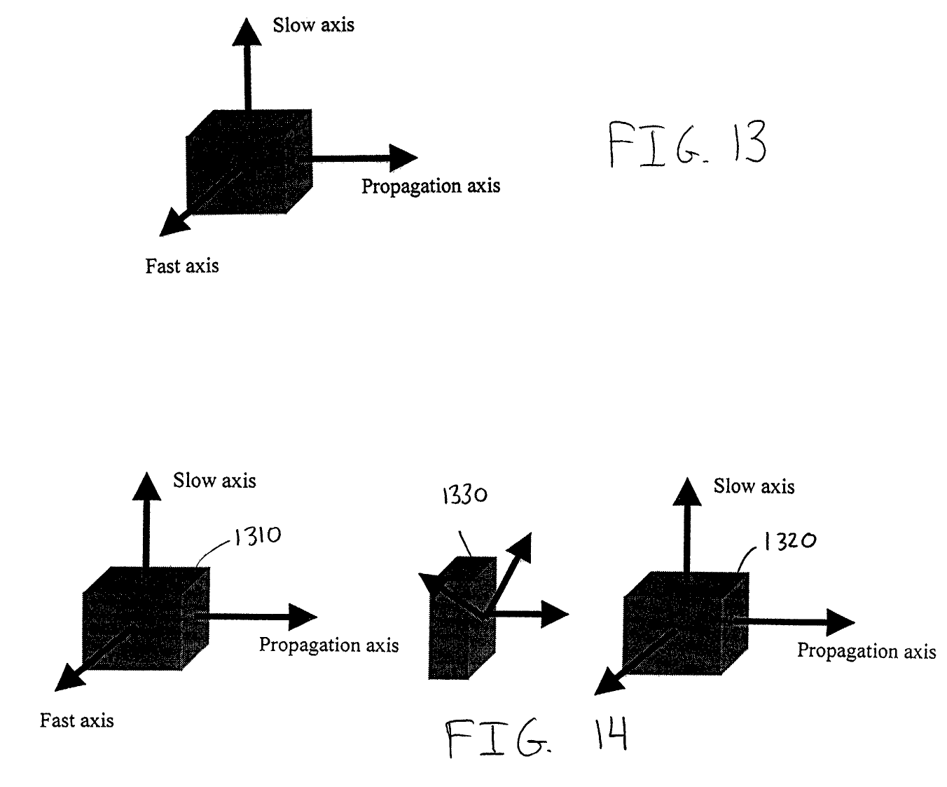

FIG. 13 shows how a birefringent crystal can be cut to have well-defined axes. Similarly, FIG. 14 shows, in a simple embodiment, the relative orientation between crystals 1310 and 1320 and intermediate liquid crystal 1330.

The overall PMD vector of compensator 1200 is such that by changing the voltage across the liquid crystal results in change in both the direction and the magnitude. Thus, if a liquid crystal has an effective retardance of a half wave, then the overall PMD of the composite structure is zero, and the principal states are collinear with the slow and the fast axes. Similarly if the retardance of the liquid crystal cell is zero, then the principal states are along the slow and the fast axis and the overall all length of the PMD vector is twice that of the single crystal (which for this example we have chosen to be the same). By changing the retardance of the intervening liquid crystal cell it can be shown that the length of the PMD vector rotates essentially, in the S₁, S₃ plane (although not exactly), as the value of the retardance is changed somewhat.

In general, if x psec is the maximum PMD that needs to be compensated, two equal length sections can be used, each with a PMD of τ/2 psec. When these two sections are combined with the appropriate relative orientation, a maximum of τ/2+τ/2=x psec delay can be obtained. Alternatively, 0 psec is possible by orienting the PMD vectors of these sections in opposite directions. Similarly, an n section system can be designed with τ/n psec worth of delay in each section. It will be appreciated that in order to achieve a 0 psec delay with equal length elements, n must be even. If the lengths are different, then n can also be odd.

Thus, it is seen that single and multi-channel PMD compensators can be used to introduce compensatory delay to counter optical input signal delay caused by PMD in multiple signals. One skilled in the art will appreciate that the present invention can be practiced by other than the described embodiments, which are presented for purposes of illustration and not of limitation. It will be further appreciated that the present invention is limited only by the claims that follow.

What is claimed is:

1. A single-channel polarization mode dispersion (“PMD”) compensator coupled to receive an optical input signal having a polarization and PMD, wherein said PMD compensator introduces compensatory delay to counter optical input signal delay caused by said PMD in said optical signal, and wherein said compensator comprises:
a polarization controller, having a retardance, that receives said optical input signal and a controller feedback signal, wherein said controller feedback signal causes said controller to adjust its retardance such that said polarization of said optical input signal is substantially aligned when it emerges from said controller;
a plurality of tuning modules connected in series with and downstream from said controller, wherein each of said tuning modules comprises:
a polarization adjustor, having a retardance, that receives an adjustor feedback signal and a compensated optical output signal from either (1) said controller or (2) another of said tuning modules, wherein said adjustor feedback signal controls said retardance of said adjuster such that said polarization of said compensated optical output signal is aligned when it emerges from said adjustor, and
a fixed length birefringent medium that receives said emerged signal from said adjustor and produces said compensated optical output signal; and
a distortion detector that receives said compensated optical output signal and provides said controller and adjustor feedback signals for compensating delay caused by said PMD in said optical input signal.

2. The PMD compensator of claim 1 wherein said controller comprises at least one stacked liquid crystal structure such that said retardance can be controlled with said controller feedback signal to align said polarization of said optical input signal.

3. The PMD compensator of claim 1 wherein said controller comprises at least four stacked liquid crystal structures that provide endless retardation adjustment to align said polarization of said optical input signal.

4. The PMD compensator of claim 1 wherein said controller comprises one liquid crystal structure such that said retardance can be controlled with said controller feedback signal to align polarization of said optical input signal, and wherein said liquid crystal structure is cascaded with at least one other retardation element.

5. The PMD compensator of claim 4 wherein said controller further comprises two quarter wave plates, that, in conjunction with said liquid crystal structure, provide limited control of said polarization of said optical input signal.

6. The PMD compensator of claim 4 wherein said at least one other retardation element comprises active liquid crystal structures.

7. The PMD compensator of claim 4 wherein said at least one other retardation element comprises at least one passive wave plate.

8. The PMD compensator of claim 1 wherein said adjustor further comprises at least one stacked liquid crystal structure such that said retardance can be controlled with said adjustor feedback signal to align said polarization of said compensated optical output signal.

9. The PMD compensator of claim 1 wherein said adjustor comprises at least four stacked liquid crystal structures that provide endless retardation adjustment to align said polarization of said compensated optical output signal.

10. The PMD compensator of claim 1 wherein said adjustor comprises one liquid crystal structure such that said retardance can be controlled with said adjustor feedback signal to align said polarization of said compensated optical output signal, wherein said liquid crystal structure is cascaded with at least one other retardation element.

11. The PMD compensator of claim 10 wherein said adjustor further comprises two quarter wave plates, that, in conjunction with said liquid crystal structure, provide limited control of said polarization of said compensated optical output signal.

12. The PMD compensator of claim 10 wherein said at least one other retardation element comprises active liquid crystal structures.

13. The PMD compensator of claim 10 wherein said at least one other retardation element comprises at least one passive wave plate.

14. A multi-channel polarization mode dispersion (PMD) compensator coupled to receive multiple optical input signals, each having a polarization and PMD, wherein said PMD compensator introduces compensatory delay to counter multiple optical input signal delays caused by said PMD in said multiple optical input signals, and wherein said compensator comprises:
a polarization controller, having a variable retardance for each signal, that receives said multiple optical input signals and at least one controller feedback signal, wherein said controller feedback signal causes said controller to adjust its retardance such that said polarizations of said multiple optical input signals are substantially aligned for downstream optical processing as they emerge from said controller;
a plurality of tuning modules connected in series with and downstream from said controller, wherein each of said tuning modules comprises:
a polarization adjustor, having a retardance, that receives an adjustor feedback signal and at least one of multiple compensated optical output signals from either (1) said controller or (2) another of said tuning modules, wherein said adjustor feedback signal controls said retardance of said adjuster such that said polarization of said at least one of said multiple compensated optical output signals are aligned when emerging from said adjustor, and
a fixed length birefringent medium that receives said multiple emerging signals from said adjustor and produces said multiple compensated optical output signals; and
a distortion detector that receives said multiple compensated optical output signals and provides said controller and adjustor feedback signals for compensating delay caused by said PMD in said multiple optical input signals.

15. The PMD compensator of claim 14 wherein said controller comprises at least one stacked liquid crystal structure such that said retardance can be controlled with said controller feedback signal to align said polarizations of said multiple optical input signals.

16. The PMD compensator of claim 14 wherein said controller comprises at least three stacked liquid crystal structures that provide endless retardation adjustment to align said polarizations of said multiple optical input signals.

17. The PMD compensator of claim 14 wherein said controller comprises one liquid crystal structure such that said retardance can be controlled with said controller feedback signal to align said polarizations of said multiple optical input signals, and wherein said liquid crystal structure is cascaded with at least one other retardation element.

18. The PMD compensator of claim 17 wherein said controller further comprises two quarter wave plates, that, in conjunction with said liquid crystal structure, provide limited control of said polarizations of said multiple optical input signals.

19. The PMD compensator of claim 17 wherein said at least one other retardation element comprises an active liquid crystal structure.

20. The PMD compensator of claim 17 wherein said at least one other retardation element comprises at least one passive wave plate.

21. The PMD compensator of claim 14 wherein said adjustor comprises at least one stacked liquid crystal structure such that each said retardance can be controlled with said adjustor feedback signal to align said polarizations of said multiple compensated optical output signals.

22. The PMD compensator of claim 14 wherein said adjustor comprises at least three stacked liquid crystal structures that provide endless retardation adjustment to align said polarizations of said multiple compensated optical output signals.

23. The PMD compensator of claim 14 wherein said adjustor comprises one liquid crystal structure such that each said retardance can be controlled with said adjustor feedback signal to align said polarizations of said multiple compensated optical output signals, wherein said liquid crystal structure is cascaded with at least one other retardation element.

24. The PMD compensator of claim 23 wherein said adjustor further comprises two quarter wave plates, that, in conjunction with said liquid crystal structure, provide limited control of said polarizations of said multiple compensated optical output signals.

25. The PMD compensator of claim 23 wherein said at least one other retardation element comprises active liquid crystal structures.

26. The PMD compensator of claim 23 wherein said at least one other retardation element comprises at least one passive wave plate.

27. A polarization mode dispersion (PMD) compensator having a folded geometry for receiving at least one optical input signal having a polarization and PMD, wherein said PMD compensator introduces compensatory delay to counter optical input signal delay caused by said PMD in said optical input signal, and wherein said compensator comprises:
a polarization controller, having a retardance, that receives said optical input signal, a compensated optical output signal, and a controller feedback signal, wherein said controller feedback signal causes said controller to adjust its retardance such that said polarization of said optical input signal and said compensated optical output signal are substantially aligned for subsequent optical processing as they emerge from said controller;
a plurality of tuning modules connected in series with and downstream from said controller, wherein each of said tuning modules comprises:
a polarization adjustor, having a retardance, that receives an adjustor feedback signal and said compensated optical output signal from either (1) said controller or (2) another of said tuning modules, wherein said adjustor feedback signal controls said retardance of said adjuster such that said polarization of said compensated optical output signal is substantially aligned for subsequent optical processing when it emerges from said adjustor, and
a fixed length birefringent medium that either receives said emerged signal from (1) said adjustor or (2) said compensated optical output signal after reflecting back by a reflector and that produces said compensated optical output signal; and
a distortion detector that receives said compensated optical output signal from said controller and provides said controller and adjustor feedback signals for compensating delay caused by said PMD in said optical input signal.

28. The PMD compensator of claim 27 wherein said controller comprises at least one stacked liquid crystal structure such that said retardance can be controlled with said controller feedback signal to align said polarization of said optical input signal.

29. The PMD compensator of claim 27 wherein said controller comprises at least three stacked liquid crystal structures that provide endless retardation adjustment to align said polarization of said optical input signal.

30. The PMD compensator of claim 27 wherein said controller comprises one liquid crystal structure such that said retardance can be controlled with said controller feedback signal to align said polarization of said optical input signal, and wherein said liquid crystal is cascaded with at least one other retardation element.

31. The PMD compensator of claim 30 wherein said controller further comprises two quarter wave plates, that, in conjunction with said liquid crystal, provide endless control of said optical input signal.

32. The PMD compensator of claim 30 wherein said at least one other retardation element comprises at least one active liquid crystal structure.

33. The PMD compensator of claim 30 wherein said at least one other retardation element comprises at least one passive wave plate.

34. The PMD compensator of claim 27 wherein said adjustor comprises at least one stacked liquid crystal structure such that said retardance can be controlled with said adjustor feedback signal to align said polarization of said compensated optical output signal.

35. The PMD compensator of claim 27 wherein said adjustor comprises at least three stacked liquid crystal structures that provide endless retardation adjustment to align said polarization of said compensated optical output signal.

36. The PMD compensator of claim 27 wherein said adjustor comprises one liquid crystal structure having a retardance that can be controlled with said adjustor feedback signal to align said polarization of said compensated optical output signal, and wherein said liquid crystal structure is cascaded with at least one other retardation element.

37. The PMD compensator of claim 36 wherein said adjustor further comprises two quarter wave plates, that, in conjunction with said liquid crystal, provide limited control of said polarization of said compensated optical output signal.

38. The PMD compensator of claim 36 wherein said at least one other retardation element comprises at least one active liquid crystal structure.

39. The PMD compensator of claim 36 wherein said at least one other retardation element comprises at least one passive wave plate.

40. An polarization mode dispersion compensator that can receive at least one optical signal having a polarization and PMD, wherein said compensator comprises:
a polarization controller comprising at least one variable retardance plate;
a plurality of tuning modules connected in series with and downstream from said controller, wherein each of said tuning modules comprises:
a polarization adjustor comprising at least one variable retardance adjuster plate, and
a fixed length birefringent medium;
a distortion analyzer coupled to either (1) said controller or (2) a last of said tuning modules, wherein said detector includes at least one photo-detector and circuitry that generates a plurality of feedback signals based on electronic signals generated by said photo-detector; and
feedback lines for providing said feedback signals from said analyzer to said controller and said tuning modules.

41. The compensator of claim 40 wherein said at least one optical signal is a single optical input signal, said variable retardance plate comprises a single-channel plate, and wherein each adjuster comprises a single-channel adjustor.

42. The compensator of claim 40 wherein said at least one optical signal comprises multiple optical input signals and said controller comprises a multi-channel, two-dimensional controller, and each of said adjustors comprises a multi-channel, two-dimensional adjustor.

43. The compensator of claim 42 further comprising at least one reflector optically coupled to an end of said compensator.
